(19) United States
(12) Patent Application Publication
(10) Pub. No.: US 2007/0232274 A1
(43) Pub. Date: Oct. 4, 2007

(54) Method, System, Wireless Communications Device and Computer Programs for Sending and Receiving Messages

(76) Inventors: Younghee Jung, Tokyo (JP); Per Persson, Stockholm (SE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/587,849

(22) PCT Filed: Apr. 29, 2004
(86) PCT No.: PCT/FI04/00261

§ 371 Date: Jan. 11, 2007

(51) Int. Cl. H04Q 7/22

(52) U.S. Cl. 455/412.1

(57) ABSTRACT

The invention discloses a delivery concept that enables a sender of a mobile message to define a specific condition for the mobile message to be notified to the recipient. A set of context parameters defined for the electronic messaging system (e.g., short message service, multimedia message service) can be employed to a messaging application. Before the user sends a message, the user selects delivery condition(s) to be used and sets its/their value. The user as a sender will choose at least one delivery condition that is appropriate to the content of the message and is effective to condition the suitable context of the recipient when the message is received and, potentially, read. The message may be delivered to the recipient's terminal device instantly but it is not shown to the recipient until at least one context least one of the sender-defined delivery conditions is met.

### BACKGROUND OF THE INVENTION

1. Field of the Invention

The present invention relates to mobile telecommunication systems. In particular, the present invention relates to a novel and improved method, wireless communications device, computer programs and system for sending and receiving messages comprising sender-defined delivery conditions.

2. Description of the Related Art

In the Internet there are applications that can be used to transmit presence information to other users. A presence application is typically a network server application although the user has to have a client application. The network server application maintains e.g. a database comprising state information of a plurality of users. Other users can acquire e.g. state information of a user or, alternatively, a user may be able to determine to whom his/her state information can be delivered. The user may also state that he/she is e.g., absent, engaged etc. at the moment so that another user willing to contact him/her has further information about the state of the user. The state of a user may also be indicated by using a special logo or a graphic figure.

The same idea of presence applications has been adopted also to mobile telecommunication networks. Leading mobile device and network suppliers, operators, information technology companies and content providers formed the Open Mobile Alliance (OMA) in June 2002. The Open Mobile Alliance is designed to be the center of mobile service standardization work, helping the creation of interoperable services across countries, operators and mobile terminals that will meet the needs of the user.

In wireless networks, the term presence takes on a richer meaning. It includes e.g. client device availability, user status, location, client device capabilities and searchable personal statuses, such as mood and hobbies.

When we approach someone for initiating a conversation, we pay attention to the situation or the environment if it is suitable for the content of the conversation. It's a social behavior that not only takes into consideration of the recipient's context so that initiating a conversation does not interrupt the recipient's ongoing activities but also of the appropriateness of the content to the context that the conversation would take place.

The rich modality of the face-to-face conversation provides enough queues in order for the user to understand, and judge the appropriateness of the content of the conversation at the given time and place. In mediated conversation, such richness is mostly lost.

The aforementioned presence applications in mobile communications provide some ways to overcome the lack of modality to understand the recipient's context by providing the availability indication for phone conversation along with manually composed status messages by the recipient before placing a phone call. However, such a mechanism has at least two limitations:
First, the availability indication has to be manually set by the user. Although manually set status indication has its own value, such as being a new emotional communication channel, forgetful users will not benefit from the services too much.
Second, the availability information only provides such a big granularity of user's context information that it does not help much e.g. in cases of sending text messages, with the exception of situations where text messages are sent to substitute the voice calls due to the unavailability of the recipient.

With its asynchronous nature, text messaging is considered to be less intrusive in that it does not require the recipient's immediate commitment to the conversation. However, as the end-users' messaging behavior is becoming more sophisticated, certain needs for richer modality in sending text messages will arise. By supporting this the chances are that the messaging could play a much more powerful role in communication than being an inferior substitute to voice calls, possibly giving a rise to new usage patterns.

Automatically detecting user's context by analyzing and interpreting the raw data that can be collected via users' mobile phones could be one way to overcome the limitations imposed by manual set-up of the status or context indication. However, the users' context information provided by the automatic system can be very accurate and detailed, which will consequently make it too sensitive to share such information with other users all the time. For instance, people may indicate strong negativity towards “passive sharing”, i.e., constant sharing of location data with other users due to privacy reasons.

There is an obvious need for a messaging solution that would take into account the receiving situation at the receiving end.

### SUMMARY OF THE INVENTION

The invention discloses a defined delivery concept for messaging in mobile communications networks. The defined delivery concept enhances the benefits and user experience of asynchronous communication by allowing the sender to declare the suitable context of the recipient in which the message is delivered to the recipient. In other words, the sender of the message defines at least one delivery condition for a message. The delivery conditions determine when the recipient of the message actually is able to read the message. The message itself may be transmitted to the recipient's wireless communication device instantly but the message is not shown to the user of the wireless communications device until at least one delivery condition is met. The maximum usage of defining the message delivery context will be possible if the sender knows about habits and daily routines of the recipient very well.

According to one aspect of the invention there is provided a method for sending a message with a wireless communications device, the method comprising composing a message with the wireless communications device, determining at least one delivery condition for the message with the wireless communications device, and sending the message including the at least one delivery condition to at least one receiving wireless communications device.

According to another aspect of the invention there is provided a method for receiving a message with a wireless communications device, the method comprising receiving a message from a sender with the wireless communications device and delaying a notification of the message to a user of the receiving wireless communications device based on at least one delivery condition defined for the message by the sender of the message.

In one embodiment of the invention, the method further comprises checking whether the message comprises at least one delivery condition, and if at least one delivery condition is detected, hiding the message from the user of the receiving wireless communications device, starting monitoring with the receiving wireless communications device at least one context parameter relevant to the at least one delivery condition defined to message, and if the at least one delivery condition matches with the at least one context parameter, generating a new message notification to the user of the receiving wireless communications device, and displaying the message to the user.

According to another aspect of the invention there is provided a computer program for sending a message with a wireless communications device, wherein the computer program comprises code adapted to perform the following steps when executed on a data-processing device: composing a message with the wireless communications device, determining at least one delivery condition for the message with the wireless communications device, and sending the message including the at least one delivery condition to at least one receiving wireless communications device. In one embodiment the computer program is stored on a data-processing device readable medium.

According to another aspect of the invention there is provided a computer program for receiving a message with a wireless communications device, wherein the computer program comprises code adapted to perform the following steps when executed on a data-processing device: receiving a message from a sender with the wireless communications device and delaying a notification of the message to a user of the receiving wireless communications device based on at least one delivery condition defined for the message by the sender of the message. In one embodiment the computer program is stored on a data-processing device readable medium.

In one embodiment of the invention the computer program is further adapted to perform the following steps when executed on the data-processing device: checking whether the message comprises at least one delivery condition; and if at least one delivery condition is detected, hiding the message from the user of the receiving wireless communications device, starting monitoring with the receiving wireless communications device at least one context parameter relevant to the at least one delivery condition defined to message, and if the at least one delivery condition matches with the at least one context parameter, generating a new message notification to the user of the receiving wireless communications device, and displaying the message to the user.

According to another aspect of the invention there is provided a wireless communications device for sending messages, the wireless communications device comprising: a central processing unit, at least one memory connected to the central processing unit, composing means configured to compose a message, determining means configured to determine at least one delivery condition for the message, and a transceiver configured to send the message including the at least one delivery condition to at least one receiving wireless communications device.

According to another aspect of the invention there is provided a wireless communications device for receiving messages, the wireless communications device comprising: a central processing unit, at least one memory connected to the central processing unit, a display connected to the central processing unit and a transceiver configured to receive a message, wherein the wireless communication device is configured to delay a notification of the message to a user the wireless communication device based on at least one delivery condition defined for the message by the sender of the message.

In one embodiment of the invention the wireless communications device further comprises checking means configured to check whether the message comprises at least one delivery condition; and if at least one delivery condition is detected, the message handling means are configured to hide the message from the user of the receiving wireless communications device, and monitoring means configured to monitor at least one context parameter relevant to the at least one delivery condition defined to message, and if the at least one delivery condition matches with the at least one context parameter, message notification means are configured to send a new message notification to the user of the receiving wireless communications device; and wherein the display is configured to display the message to the user.

In one embodiment of the invention the at least one delivery condition comprises at least one of the following: an expiration time/date parameter, a message delivery behaviour parameter upon expiration time, a request of delivery receipt parameter, a location parameter, a phone call parameter, a time parameter and an external device parameter.

According to another aspect of the invention there is provided a system for transmitting messages. The system comprises a communications network, a sending wireless communications device connected to the communications network and a receiving wireless communications device connected to the communications network. The communications network is configured to receive a message from the sending wireless communications device, wherein the message comprises at least one delivery condition assigned for the message by the sending wireless communications device, and to transmit the message to the receiving wireless communications device, wherein the message comprises at least one delivery condition assigned for the message by the sending wireless communications device.

According to another aspect of the invention there is provided a computer program for receiving and transmitting messages. The computer program comprises code adapted to perform the following steps when executed on a data-processing device: receiving a message from a wireless communications device, wherein the message comprises at least one delivery condition assigned for the message by the sender of the message, and transmitting the message to a receiving wireless communications device, wherein the message comprises at least one delivery condition assigned for the message by the sender of the message. In one embodiment the computer program is stored on a data-processing device readable medium.

As for further characteristics of the invention reference is made to the claims.

The present invention has several advantages over the prior-art solutions. The defined delivery system disclosed in the invention adds another dimension and option to mobile messaging, which brings clear user benefits when applied.

Due to the invention a user is able to determine at least one delivery condition for a message, whereupon the message is displayed to the receiver based on the delivery conditions.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating one embodiment of a method according to the invention,

FIG. 2 is a block diagram illustrating one embodiment of a wireless communication device according to the invention,

FIG. 3 is a flow diagram illustrating another embodiment of a method according to the invention,

FIG. 4 is a block diagram illustrating another embodiment of a wireless communication device according to the invention, and

FIG. 5 is a block diagram illustrating one embodiment of a system according to the invention.

### DETAILED DESCRIPTION OF THE PREFERRED EMBODIMENTS

Reference will now be made in detail to the embodiments of the present invention, examples of which are illustrated in the accompanying drawings.

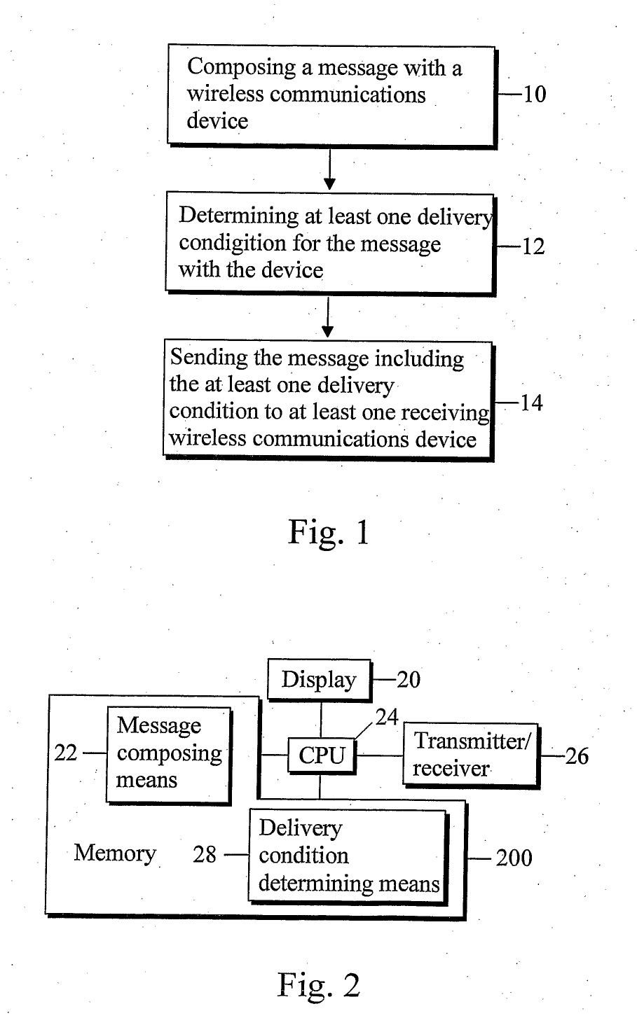

FIG. 1 is a flow diagram illustrating one embodiment of a method according to the invention.

Particularly, the method disclosed in FIG. 1 relates to a wireless communications device sending a message.

The message is e.g. a short message (SMS), a multimedia message (MMS) etc. Therefore, the wireless communications device is e.g. a mobile phone.

A set of delivery parameters defined for electronic messaging systems can be employed to the messaging application. Before the user sends a message, the user selects delivery condition(s) to be used and sets its/their value.

The user as a sender chooses at least one delivery condition that is appropriate to the content of the message and is effective to a suitable context of the recipient when the message is received and, potentially, read. In practice, the more the sender is familiar with the habits of the recipient, the more effective the selection of such parameters will be.

At step 10 a user of the mobile phone composes a message with the mobile phone. The message is composed e.g. using a message editor of the mobile phone. It is evident that also other appropriate means can be used to compose the message. At step 12 e.g. the message editor provides the user interface to add one or more delivery conditions to the message. By knowing the message delivery context, the sender can compose more meaningful and expressive messages. The message editor or other means for composing the message provides the sender also with other conditions for defined delivery behaviour, such as expiration time/date, message delivery behaviour upon expiration time, request of delivery receipt, a location parameter, a phone call parameter, a time parameter and an external device parameter.

In one embodiment a time parameter is a special class of delivery parameter that can override the normal delivery parameter, e.g. location. For example, if a location delivery parameter is not fulfilled for five days, and the time parameter is set as ‘five days’, this will override the location parameter and deliver the message then.

In another embodiment a time parameter may refer to a termination of a message. Instead of forcing the message to be delivered by the special parameter overriding the primary parameter, the wireless communications device may erase the undelivered message. For example, a user may set up the deletion of a message with set time deadline. The message is delivered with a location parameter: “I work in the cafe ABC near here this week. Please drop by.” The sender wants to deliver the message whenever the user comes nearby his work place for the week, but wants delete this message if it is not delivered within one week, since the message content will become invalid after this date.

In yet another embodiment the user may also determine dependencies between the defined delivery parameters. The user may use e.g. logical operations.

Expiration time and date may be set to define further for a defined delivery message not notified to the recipient till this set time to behave in a certain way. The sender can set the expiration time and set an undelivered message to be automatically deleted or delivered without taking into consideration of another defined delivery condition. A delivery receipt request can prompt the recipient of the defined delivery message to consent sending back a delivery report upon closing the message from a viewing mode.

At step 14 the message including the at least one delivery condition is sent to at least one receiving mobile phone. A delivery condition may refer to a plurality of different parameters. In the following a few of them is disclosed in more detail:
Time parameter. The message is notified to the receiver after a set time.
Location parameter. Delivery location can be defined by a number of ways. In one implementation the location parameter is a cell identifier of a mobile communications network. It is evident that the location parameter may also refer to any other appropriate form of a location parameter
Bluetooth parameter. The parameter identifies a certain Bluetooth device.
Phone call parameter. The parameter refers to a certain phone number.

It is evident that the list above is only exemplary and in another embodiment of the invention also other parameters can be used.

FIG. 2 discloses one embodiment of a wireless communications device sending the aforementioned message. The wireless communications device is e.g. a mobile phone. The mobile phone comprises at least a central processing unit 24, which is connected to a display 20, message composing means 22, delivery condition determining means 28 and a transmitter/receiver 26. Message composing means 22 and delivery condition determining means 28 refer e.g. to a message editor application of the wireless communications device. The message editor application enables a sender of the message to define one or more delivery conditions to the message. Transmitter/receiver 26 sends the composed message to at least one receiver.

The mobile phone comprises also a memory 200 that may refer to a single memory or memory area or to a plurality memories or memory areas that may include e.g. random access memories (RAM), read-only memories (ROM) etc. Memory 200 may also include other applications or software components that are not described in more detail and also may include a computer program (or portion thereof), which when executed on the central processing unit 24 performs at least some of the method steps of the invention.

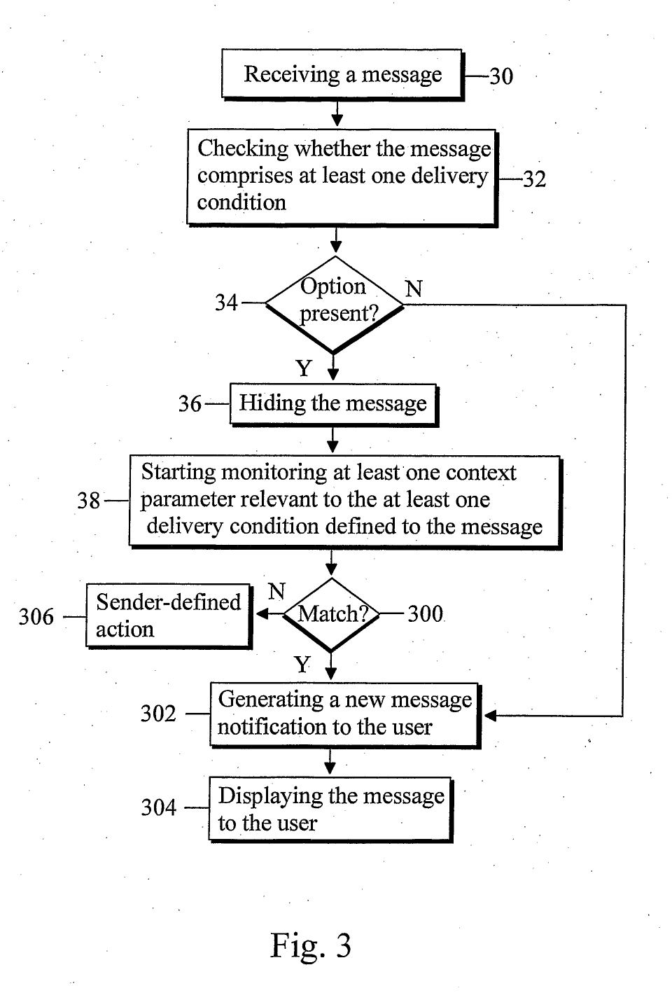

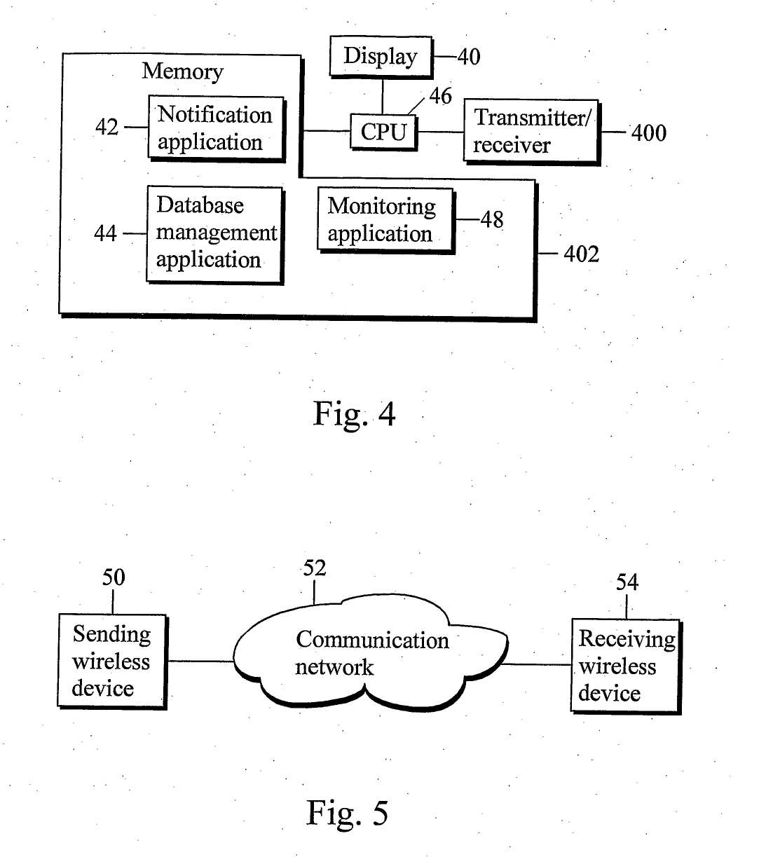

FIG. 3 is a flow diagram illustrating another embodiment of a method according to the invention. FIG. 4 will be described together with FIG. 3. FIG. 4 discloses a block diagram illustrating another embodiment of a wireless communication device according to the invention. The wireless communications device is e.g. a mobile phone. It is evident that the wireless communications device may refer to any other appropriate device other than the mobile phone that is able to send and receive messages.

In general, message-handling means 42 of the wireless communication device are configured to delay a notification of the message to a user the wireless communication device based on at least one delivery condition defined for the message by the sender of the message.

At step 30 a receiving wireless communications device receives a message with a receiver 400.

Checking means, e.g. a notification application 42 checks whether the message includes one or more delivery conditions or not, as illustrated at step 32. If the message does not contain any delivery conditions, step 34, message notification means, e.g. notification application 42 sends a new message notification to the user of the mobile phone, as illustrated at step 302. At step 304 the message is displayed to the user of the mobile phone with a display 40.

FIG. 4 discloses that a memory 402 includes a plurality of different applications. Memory 402, receiver 400 and display 40 are connected to a central processing unit 46.

If there is a delivery condition associated with the message, notification application 42 will not give out the notification but instead informs monitoring means, e.g. a monitoring application 48 of the message. Furthermore, as illustrated at step 36, the message-handling means 42 is configured to hide the message from the user of the mobile phone when delivery conditions are present in the message. Monitoring means, e.g. monitoring application 48 is an observer application on the mobile phone that automatically starts with an operating system. Monitoring application 48 activates the observation behaviours appropriate for the hidden defined delivery messages, received on the phone already and waiting to be delivered to the user, as illustrated at step 38. To make the observation behaviour effective, monitoring application 48 may only take into account delivery conditions that are associated with the defined delivery messages to be delivered. In one embodiment the sender may also have determined dependencies between the delivery conditions, e.g. by using logical operations.

In the following examples are disclosed of what effects each parameter may have over the behaviour of monitoring application 48:
Time parameter: Monitoring application 48 parses the time format defined by the sender of the message. It can be either a set of Year/Month/Day/Time, or a set duration from the sending time. Monitoring application 48 will check the mobile phone's system clock and compare it with this defined time.
Location parameter: Delivery location can be defined by a number of ways. In one implementation the location parameter is a cell identifier of a mobile communications network. Monitoring application 48 will start checking the recognized cell identifier and compare it with the cell identifier specified with the defined delivery message.
Bluetooth parameter: Monitoring application 48 will start scanning for a particular Bluetooth device address at a regular interval.
Phone call parameter: Monitoring application 48 will monitor the incoming and outgoing phone call activities on the phone for the phone number specified in the defined delivery message.

It is evident that the list above is only exemplary and in another embodiment of the invention also other parameters can be used.

When monitoring application 48 detects one or more context parameters meeting at least one delivery condition value, step 300, monitoring application 48 requests message notification means, e.g. notification application 42 to generate a new message notification to the user of the mobile phone and to unhide the defined delivery message in a message inbox, as illustrated at steps 302 and 304. In one embodiment a user may also have determined dependencies between the delivery conditions. The user may use e.g. logical operations.

The hid defined delivery message received in the recipient's phone at a certain time becomes visible in the inbox upon the new message notification is given. This process assigns a new time stamp to the defined delivery message. The new time stamp is different from the original time stamp value that the defined delivery message was first received on the phone. ‘Message detail’ accessible through the message viewer only shows the newly assigned time stamp of the defined delivery message which is same as the time stamp of the new message notification.

The sender of the message may have set delivery conditions also for a case that none of the actual delivery conditions is not met at the receiving end.

These additional parameters may comprise e.g. an expiration time/date, defined delivery message delivery behaviour upon expiration time, and request of delivery receipt. Expiration time and date is set to define further for the defined delivery message not notified to the recipient till this set time to behave in a certain way, as illustrated at step 306. The sender can set the expiration time and set the undelivered message to be automatically deleted or delivered without taking into consideration of the delivery condition. Delivery receipt request can prompt the recipient of delivery message to consent sending back a delivery report upon closing the message from viewing mode.

In one embodiment of the invention, a delivery condition might be set to utilize information from a database external to the native messaging application. Collecting means, e.g. a database management application 44 is used to collect the necessary information and construct databases, and manage the databases including sharing with other users, ensuring the compatibility of the collected data. For instance, a location database may collect network cell identifiers in a particular format that can be understood by monitoring application 48 of the message recipient's phone with a compatible access to the cell identifier information. A contact database may collect contact information of recipients.

In one embodiment a recipient does not necessarily need to have a parameter value (e.g. the location label) in a received message in his/her database. In another embodiment a recipient does not need to have a phone number (delivery parameter) in his/her contact database. The database is one way for the sender to identify/specify the context parameter, and to create meaningful labels attached to them so that they can be identified in a meaningful way by the sender.

A user of the mobile phone may have an interface to collect, delete, and modify location labels. Items in a database may be collected by just clicking a button (e.g. save my current location, save my current nearby Bluetooth devices). Besides sharing labels, self-collection of valuable context items is another way of building up one's databases. Furthermore, a database application allows a user to attach labels, image and even annotations to the collected ‘raw’ context data. For example, a cell identifier, or a Bluetooth Media Access Control (MAC) address may be useless for the sender unless there is a meaningful label. Adding an image may be important since images and verbal labels have the potential to describe very different things and be understood in different ways (especially when you share the labeled/‘imaged’ database items with others.

Furthermore, users can share the collected labels with other users. Sharing of the location labels can happen through the defined delivery message exchange. For instance, if a user sends a defined delivery message with a location label which the recipient does not have in his/her database application, the defined delivery message viewer automatically prompts the user to save the label embedded in the received defined delivery message to a compatible database. Therefore, each data that belong to a database has a database identifier. Furthermore, multiple database items can be shared at once by sending the selected database items to a recipient (independent of any defined delivery message), who is then able to import all labelled context into her database, Database management application 44 can be expanded with additional databases if the mobile phone's capability is enhanced, e.g., with an Aided Global Positioning System (GPS) hardware module. However, in this case, the user is able to utilize the expanded database for a delivery condition only with message recipients' phones with the equal capability.

In one embodiment of the invention monitoring application 48 also needs to check for the availability of the observation behaviour in the terminal, in case the sender defined the delivery parameter with a database not available on the recipient's phone. Monitoring application 48 decides how to deliver the defined delivery message in such a case, depending on the definition set by the recipient and sender. Parameters not exemplified above could be expanded as desired by the terminal manufacturers so long as enough compatibility is ensured, such as a phone profile status change, a messaging application login status if the server connection is available.

Memory 402 may refer to a single memory or memory area or to a plurality memories or memory areas that may include e.g. random access memories (RAM), read-only memories (ROM) etc. Memory 402 may also include other applications or software components that are hot described in more detail and also may include a computer program (or portion thereof), which when executed on the central processing unit 46 performs at least some of the method steps of the invention.

FIG. 5 is a block diagram illustrating one embodiment of a system according to the invention. The system comprises a sending wireless device 50, a receiving wireless device 54 and a communications network 52 between the devices. Communications network 52 is configured to receive a message from sending wireless communications device 50, wherein the message comprises at least one delivery condition assigned for the message by the sending wireless communications device. Furthermore, communications network 52 is configured to transmit the message to receiving wireless communications device 54, wherein the message comprises at least one delivery condition assigned for the message by the sending wireless communications device. Communications network 52 is e.g. a telecommunication network or a mobile telecommunication network, e.g. a Wireless Local Area Network (WLAN), a Global System for Mobile communication (GSM) network, a Universal Mobile Telecommunications Service (UMTS) network etc. In one embodiment, communications network may include several separate communications networks.

It is obvious to a person skilled in the art that with the advancement of technology, the basic idea of the invention may be implemented in various ways. The invention and its embodiments are thus not may vary within the scope of the claims.

1. A method, comprising:
composing a message with a wireless communications device;
determining at least one delivery condition for the message with the wireless communications device, the at least one delivery condition causing a notification of the message to be delayed in a receiving wireless communication device; and
sending the message including the at least one delivery condition to at least one receiving wireless communications device.

2. The method according to claim 1, further comprising at least one of:
composing the message with a message editor of the wireless communications device; and
determining the at least one delivery condition for the message with the message editor of the wireless communications device.

3. The method according to claim 1, wherein the at least one delivery condition comprises at least one of the following:
an expiration time/date parameters,
a message delivery behaviour parameter upon expiration time,
a request of delivery receipt parameters,
a location parameter,
a phone call parameter,
a time parameter, and
an external device parameter.

4. A method comprising:
receiving at a receiving wireless communications device a message from a sender with a wireless communications device; and
delaying a notification of the message to a user of the receiving wireless communications device based on at least one delivery condition defined for the message by the sender of the message.

5. The method according to claim 4, further comprising:
checking whether the message comprises the at least one delivery condition; and
if the at least one delivery condition is detected,
hiding the message from the user of the receiving wireless communications device, and
starting monitoring with the receiving wireless communications device of at least one context parameter relevant to the at least one delivery condition defined for the message;
if the at least one delivery condition matches with the at least one context parameter, giving a new message notification to the user of the receiving wireless communications device; and
displaying the message to the user.

6. The method according to claim 5, further comprising:
setting a new time stamp for the message before displaying the message to the user.

7. The method according to claim 4, further comprising:
checking whether the message comprises the at least one delivery condition; and
if the at least one delivery condition is not detected, generating a new message notification to the user of the receiving wireless communications device; and
displaying the message to the user.

8. The method according to claim 5, further comprising:
storing the at least one context parameter in at least one of the receiving wireless communications device and a device external to the receiving wireless communications device.

9. The method according to claim 8, further comprising:
collecting context parameters; and
storing the collected context parameters on a database in the wireless communications device.

10. The method according to claim 4, further comprising:
fulfilling a message sender-defined action if the at least one delivery condition is not met.

11. The method according to claim 4, further comprising:
configuring the at least one delivery condition to comprise at least one of the following
an expiration time/date parameter,
a message delivery behaviour parameter upon expiration time,
a request of delivery receipt parameter,
a location parameter,
a phone call parameter,
a time parameter, and
an external device parameter.

12. A computer program embodied on a computer-readable medium, the computer program configured to comprise:
composing a message with a wireless communications device;
determining at least one delivery condition for the message with the wireless communications device, the at least one delivery condition causing a notification of the message to be delayed in a receiving wireless communications device; and
sending the message including the at least one delivery condition to at least one receiving wireless communications device.

13. The computer program according to claim 12, further comprising:
composing the message with a message editor of the wireless communications device; and
determining the at least one delivery condition for the message with the message editor of the wireless communications device.

14. The computer program according to claim 12, further comprising:
configuring the at least one delivery condition to comprise at least one of the following:
an expiration time/date parameter,
a message delivery behaviour parameter upon expiration time,
a request of delivery receipt parameter,
a location parameter,
a phone call parameter,
a time parameter, and
an external device parameter.

15. The computer program according to claim 12, further comprising:
defining the computer readable-medium to comprise a data-processing device readable medium.

16. A computer program embodied on a computer-readable medium, the computer program configured to comprise:
receiving at a receiving wireless communications device a message from a sender with a wireless communications device; and
delaying a notification of the message to a user of the receiving wireless communications device based on at least one delivery condition defined for the message by the sender of the message.

17. The computer program according to claim 16, further comprising:
checking whether the message comprises at least one delivery condition;
if the at least one delivery condition is detected,
hiding the message from the user of the receiving wireless communications device, and
starting monitoring with the receiving wireless communications device at least one context parameter relevant to the at least one delivery condition defined for the message; and
if the at least one delivery condition matches with the at least one context parameter, generating a new message notification to the user of the receiving wireless communications device; and
displaying the message to the user.

18. The computer program according to claim 16, further comprising:
setting a new time stamp for the message before displaying the message to the user.

19. The computer program according to claim 16, further comprising:
checking whether the message comprises the at least one delivery condition;
if the at least one delivery condition is not detected, generating a new message notification to the user of the receiving wireless communications device; and
displaying the message to the user.

20. The computer program according to claim 17, further comprising:
storing the at least one context parameter in at least one of the receiving wireless communications device and a device external to the receiving wireless communications device.

21. The computer program according to claim 20, further comprising:
collecting context parameters; and
storing the collected context parameters on a database in the wireless communications device.

22. The computer program according to claim 16, further comprising:
fulfilling a message sender-defined action if the at least one delivery condition is not met.

23. The computer program according to claim 16, further comprising:
configuring the at least one delivery condition to comprise at least one of the following:
an expiration time/date parameters,
a message delivery behaviour parameter upon expiration time,
a request of delivery receipt parameter,
a location parameter,
a phone call parameter,
a time parameter, and
an external device parameter.

24. The computer program according to claim 16, further comprising:
defining the computer-readable medium to comprise a data-processing device readable medium.

25. A wireless communications device, comprising:
a central processing unit;
at least one memory operably connected to the central processing unit;
a composing unit configured to compose a message;
a determining unit configured to determine at least one delivery condition for the message, the at least one delivery condition causing a notification of the message to be delayed in a receiving wireless communications device; and
a transceiver configured to send the message including the at least one delivery condition to at least one receiving wireless communications device.

26. The wireless communications device according to claim 25, further comprising:
a message editor configured to at least one of compose the message and determine the at least one delivery condition for the message.

27. The wireless communications device according to claim 25, wherein the at least one delivery condition comprises at least one of the following:
an expiration time/date parameter,
a message delivery behaviour parameter upon expiration time,
a request of delivery receipt parameter,
a location parameter,
a phone call parameter,
a time parameter, and
an external device parameter.

28. A wireless communications device, comprising:
a central processing unit;
at least one memory operably connected to the central processing unit;
a display operably connected to the central processing unit;
a transceiver configured to receive a message; and
a message handling unit configured to delay a notification of the message to a user the wireless communication device based on at least one delivery condition defined for the message by a sender of the message.

29. The wireless communications device according to claim 28, further comprising:
a checking unit configured to check whether the message comprises the at least one delivery condition, wherein if the at least one delivery condition is detected, the message handling unit is configured to hide the message from the user of a receiving wireless communications device;
a monitoring unit configured to monitor at least one context parameter relevant to the at least one delivery condition defined for the message; and
if the at least one delivery condition matches with the at least one context parameter, the wireless communications device further comprises
a message notification unit configured to generate a new message notification to the user of the receiving wireless communications device, wherein the display is configured to display the message to the user.

30. The wireless communications device according to claim 29, wherein the wireless communications device is configured to set a new time stamp for the message before displaying the message to the user.

31. The wireless communications device according to claim 28, further comprising:
a checking unit configured to check whether the message comprises the at least one delivery condition; and
if the at least one delivery condition is not detected, a message notification unit is configured to generate a new message notification to the user of a receiving wireless communications device, wherein the display is configured to display the message to the user.

32. The wireless communications device according to claim 29, wherein the at least one context parameter is stored in at least one of the receiving wireless communications device and a device external to the receiving wireless communications device.

33. The wireless communications device according to claim 32, further comprising:
a collecting unit configured to collect context parameters; and
a database configured to store the collected context parameters.

34. The wireless communications device according to claim 28, wherein the message handling unit is configured to fulfill a message sender-defined action if the at least one delivery condition is not met.

35. The wireless communications device according to claim 28, wherein the at least one delivery condition comprises at least one of the following:
an expiration time/date parameter,
a message delivery behaviour parameter upon expiration time,
a request of delivery receipt parameter,
a location parameter,
a phone call parameter,
a time parameter, and
an external device parameter.

36. A system configured to transmit messages, comprising:
a communications network;
a sending wireless communications device operably connected to the communications network; and
a receiving wireless communications device operably connected to the communications network,
wherein the communications network is configured to receive a message from the sending wireless communications device, wherein the message comprises at least one delivery condition assigned for the message by the sending wireless communications device, the at least one delivery condition causing a notification of the message to be delayed in the receiving wireless communication device, and to transmit the message to the receiving wireless communications device, wherein the message comprises the at least one delivery condition assigned for the message by the sending wireless communications device.

37. The system according to claim 36, wherein the communications network is a telecommunication network.

38. A computer program embodied on a computer-readable medium, the computer program configured to comprise:
receiving a message from a wireless communications device, wherein the message comprises at least one delivery condition assigned for the message by a sender of the message, the at least one delivery condition causing a notification of the message to be delayed in a receiving wireless communications device; and
transmitting the message to the receiving wireless communications device, wherein the message comprises the at least one delivery condition assigned for the message by the sender of the message.

39. The computer program according to claim 38, further comprising:
defining the computer-readable medium to comprise a data processing device readable medium.

40. A wireless communications device, comprising:
central processing means;
at least one memory operably connected to the central processing means;
composing means for composing a message;
determining means for determining at least one delivery condition for the message, the at least one delivery condition causing a notification of the message to be delayed in a receiving wireless communications device; and
transceiver means for sending the message including the at least one delivery condition to at least one receiving wireless communications device.

41. A wireless communications device, comprising:
central processing means;
at least one memory means for being operably connected to the central processing means;
display means for being operably connected to the central processing means;
transceiver for receiving a message; and
message handling means for delaying a notification of the message to a user the wireless communication device based on at least one delivery condition defined for the message by a sender of the message.

42. A system configured for transmitting messages, comprising:
communications network means;
sending wireless communications means for being operably connected to the communications network; and
receiving wireless communications means for being operably connected to the communications network,
wherein the communications network is provided for receiving a message from the sending wireless communications device, wherein the message comprises at least one delivery condition assigned for the message by the sending wireless communications device, the at least one delivery condition causing a notification of the message to be delayed in the receiving wireless communication device, and for transmitting the message to the receiving wireless communications device, wherein the message comprises the at least one delivery condition assigned for the message by the sending wireless communications device.
